(19) United States
(12) Patent Application Publication
(10) Pub. No.: US 2020/0034919 A1
(43) Pub. Date: Jan. 30, 2020

(54) BLOCKCHAIN-BASED SERVICE RENTAL METHODS AND DEVICES

(71) Applicant: Alibaba Group Holding Limited, George Town (KY)

(72) Inventors: Honglin Qiu, Hangzhou (CN); Hui Zhang, Beijing (CN)

(73) Assignee: Alibaba Group Holding Limited, George Town (KY)

(21) Appl. No.: 16/523,018

(22) Filed: Jul. 26, 2019

(30) Foreign Application Priority Data
Jul. 27, 2018 (CN) 201810847144.9

(51) Int. Cl. G06Q 30/06; G06Q 40/02; H04L 9/06; G06F 16/182; G06Q 20/38

(52) U.S. Cl. CPC G06Q 30/0645; G06Q 40/025; G06Q 20/3825; G06F 16/182; H04L 9/0637

(57) ABSTRACT

A rental request initiated by a target user for a target service in a blockchain network is received. In response to the rental request, a credit risk assessment on the target user is performed. A determination is performed as to whether the target user passes the credit risk assessment. In response to determining that the target user passes the credit risk assessment, an electronic rental contract that corresponds to the target service is generated. The electronic rental contract is delivered to the target user and a service provider of the target service, in which the target user and the service provider perform an electronic signature on the electronic rental contract. The electronic rental contract with electronic signatures is stored in a distributed blockchain database of the blockchain network, in which the electronic rental contract is used to assess credit information of the target user.

### CROSS-REFERENCE TO RELATED APPLICATIONS

This application claims priority to Chinese Patent Application No. 201810847144.9, filed on Jul. 27, 2018, which is hereby incorporated by reference in its entirety.

### TECHNICAL FIELD

One or more implementations of the present specification relate to the field of blockchain technologies, and in particular, to blockchain-based service rental methods and devices.

### BACKGROUND

A blockchain technology, also referred to as a distributed ledger technology, is an emerging technology where several computing devices jointly participate in “accounting” and jointly maintain a complete distributed database. The blockchain technology features decentralization, openness, and transparency. In the blockchain technology, each computing device can participate in database recording, and data synchronization can be quickly performed between computing devices. Therefore, the blockchain technology has been extensively applied.

### SUMMARY

The present specification provides a blockchain-based service rental method, where the method includes: receiving a rental request initiated by a target user for a target service; performing credit risk assessment on the target user in response to the rental request; if the target user passes the credit risk assessment, creating an electronic rental contract that corresponds to the target service, and delivering the electronic rental contract to the target user and a service provider of the target service, where the target user and the service provider perform an electronic signature on the electronic rental contract; and storing the electronic rental contract with electronic signatures in a distributed blockchain database, where the electronic rental contract stored in the distributed blockchain database is used to assess credit information of the target user.

Optionally, the method further includes: receiving a performance record of the target user and a performance record of the service provider that correspond to the electronic rental contract; and storing the performance records in the distributed blockchain database.

Optionally, the method further includes: reading the electronic rental contract stored in the distributed blockchain database, and the performance record of the target user and the performance record of the service provider that correspond to the electronic rental contract; and performing credit assessment on the target user and the service provider based on the read electronic rental contract and the read performance records, to obtain the credit information of the target user and credit information of the service provider.

Optionally, the performing credit risk assessment on the target user in response to the rental request includes: performing identity authentication on the target user in response to the rental request; and if the identity authentication of the target user succeeds, further performing credit risk assessment on the target user.

Optionally, the credit information includes a credit score; and

The performing credit risk assessment on the target user includes: reading a credit score of the target user; determining whether the credit score of the target user is less than a predetermined threshold; and if the credit score of the target user is less than the predetermined threshold, determining that the target user fails to pass the credit risk assessment; or if the credit score of the target user is not less than the predetermined threshold, determining that the target user passes the credit risk assessment.

Optionally, the method further includes: performing credit risk assessment on the service provider; and if the service provider fails to pass the credit risk assessment, marking the service provided by the service provider as an untrusted service; or deleting the service from a trusted service list.

Optionally, the target service is a house rental service.

The present specification further provides a blockchain-based service rental apparatus, where the apparatus includes: a receiving module, configured to receive a rental request initiated by a target user for a target service; an assessment module, configured to perform credit risk assessment on the target user in response to the rental request; a creation module, configured to: if the target user passes the credit risk assessment, create an electronic rental contract that corresponds to the target service, and deliver the electronic rental contract to the target user and a service provider of the target service, where the target user and the service provider perform an electronic signature on the electronic rental contract; and a storage module, configured to store the electronic rental contract with electronic signatures in a distributed blockchain database, where the electronic rental contract stored in the distributed blockchain database is used to assess credit information of the target user.

Optionally, the receiving module is further configured to receive a performance record of the target user and a performance record of the service provider that correspond to the electronic rental contract; and the storage module is further configured to store the performance records in the distributed blockchain database.

Optionally, the assessment module is further configured to: read the electronic rental contract stored in the distributed blockchain database, and the performance record of the target user and the performance record of the service provider that correspond to the electronic rental contract; and perform credit assessment on the target user and the service provider based on the read electronic rental contract and the read performance records, to obtain the credit information of the target user and credit information of the service provider.

Optionally, the apparatus further includes: an authentication module, configured to perform identity authentication on the target user in response to the rental request, where if the identity authentication of the target user succeeds, the assessment module further performs credit risk assessment on the target user.

Optionally, the credit information includes a credit score.

The assessment module is further configured to: read a credit score of the target user; determine whether the credit score of the target user is less than a predetermined threshold; and if the credit score of the target user is less than the predetermined threshold, determine that the target user fails to pass the credit risk assessment; or if the credit score of the target user is not less than the predetermined threshold, determine that the target user passes the credit risk assessment.

Optionally, the assessment module is further configured to: perform credit risk assessment on the service provider; and if the service provider fails to pass the credit risk assessment, mark the service provided by the service provider as an untrusted service; or delete the service from a trusted service list.

Optionally, the target service is a house rental service.

The present specification further provides a blockchain-based service rental system, where the system includes: a service management subsystem, configured to receive a rental request initiated by a target user for a target service; and a credit assessment subsystem, configured to perform credit risk assessment on the target user in response to the rental request, where the service management subsystem is further configured to: if the target user passes the credit risk assessment, create an electronic rental contract that corresponds to the target service, and deliver the electronic rental contract to the target user and a service provider of the target service, where the target user and the service provider perform an electronic signature on the electronic rental contract; and store the electronic rental contract with electronic signatures in a distributed blockchain database, where the electronic rental contract stored in the distributed blockchain database is used to assess credit information of the target user.

Optionally, the service management subsystem is further configured to: receive a performance record of the target user and a performance record of the service provider that correspond to the electronic rental contract; and store the performance records in the distributed blockchain database.

Optionally, the credit assessment subsystem is further configured to: read the electronic rental contract stored in the distributed blockchain database, and the performance record of the target user and the performance record of the service provider that correspond to the electronic rental contract; and perform credit assessment on the target user and the service provider based on the read electronic rental contract and the read performance records, to obtain the credit information of the target user and credit information of the service provider.

Optionally, the system further includes: a user authentication subsystem, configured to perform identity authentication on the target user in response to the rental request, where if the identity authentication of the target user succeeds, the credit assessment subsystem further performs credit risk assessment on the target user.

Optionally, the credit assessment subsystem is further configured to: perform credit risk assessment on the service provider; and if the service provider fails to pass the credit risk assessment, mark the service provided by the service provider as an untrusted service; or delete the service from a trusted service list.

Optionally, the user authentication subsystem is a third-party system interconnected with the service management subsystem.

The present specification further provides an electronic device, including: a processor; and a memory, configured to store a machine-executable instruction, where by reading and executing a machine-executable instruction that is stored in the memory and that corresponds to blockchain-based service rental control logic, the processor is enabled to: receive a rental request initiated by a target user for a target service; perform credit risk assessment on the target user in response to the rental request; if the target user passes the credit risk assessment, create an electronic rental contract that corresponds to the target service, and deliver the electronic rental contract to the target user and a service provider of the target service, where the target user and the service provider perform an electronic signature on the electronic rental contract; and store the electronic rental contract with electronic signatures in a distributed blockchain database, where the electronic rental contract stored in the distributed blockchain database is used to assess credit information of the target user.

In the previously described technical solution, based on the credit risk assessment result of the user who requests the rental service, the electronic rental contract may be automatically created for the user by combining the credit risk assessment mechanism with the evidence storage mechanism of the blockchain, and the electronic rental contract with the electronic signatures can be stored in the blockchain as evidence, so that the real rental transaction can be generated online, in the rental service system by using a feature that stored evidence data in the blockchain is unchangeable, for the user who requests the rental service.

In addition, because the electronic rental contract stored in the blockchain as evidence can also be used as the credit assessment data in the credit assessment of the user, a process of performing credit assessment on the user and a process of creating the real rental transaction online for the user based on the credit assessment result can form a completely closed service loop, and the electronic rental contract that is created online for the user can be reversely used in the credit assessment of the user, to form a personal credit record of the user.

### BRIEF DESCRIPTION OF DRAWINGS

FIG. 1 is a flowchart illustrating a blockchain-based service rental method, according to an example implementation;

FIG. 2 is an architectural diagram illustrating a house rental system, according to an example implementation;

FIG. 3 is a schematic structural diagram illustrating an electronic device, according to an example implementation; and

FIG. 4 is a logical block diagram illustrating a blockchain-based service rental apparatus, according to an example implementation.

### DESCRIPTION OF IMPLEMENTATIONS

The present specification is intended to provide a technical solution. In the technical solution, a credit risk assessment mechanism and an evidence storage mechanism of a blockchain are combined, so that a real rental transaction is created online for a user who requests a rental service based on a credit risk assessment result of the user, and credit assessment of the user is reversely implemented based on a record of the real rental transaction that is created online for the user, to form a closed service loop.

During implementation, when a rental request initiated by a target user for a target service is received, credit risk assessment can be initiated for the target user in response to the rental request.

For example, a credit score of the user may be obtained by performing credit assessment on the user in advance. When the credit risk assessment is performed on the user, the credit score of the user can be read, and the credit score is compared with a predetermined risk threshold to determine whether the user has a credit risk.

If the target user passes the credit risk assessment, an electronic rental contract that corresponds to the target service can be created online for the target user.

For example, the target service is a house rental service. The electronic rental contract may be an electronic rental contract. An electronic rental contract template may be preconfigured at the back end of a rental service system. After the user passes credit risk assessment of the rental service system, the electronic rental contract may be automatically created for the user based on a preconfigured electronic rental contract template and related house information (for example, a rental period and a rent).

After the electronic rental contract is created online for the user, the electronic rental contract may be delivered to the user and a service provider of the target service. The user and the service provider perform an electronic signature on the electronic rental contract, and the electronic rental contract with electronic signatures is then stored in a distributed blockchain database as evidence. Subsequently, the electronic rental contract stored in the blockchain as evidence may be further used as credit assessment data in the credit assessment of the user.

In the previously described technical solution, based on the credit risk assessment result of the user who requests the rental service, the electronic rental contract may be automatically created for the user by combining the credit risk assessment mechanism with the evidence storage mechanism of the blockchain, and the electronic rental contract with the electronic signatures can be stored in the blockchain as evidence, so that the real rental transaction can be generated online, in the rental service system by using a feature that stored evidence data in the blockchain is unchangeable, for the user who requests the rental service.

In addition, because the electronic rental contract stored in the blockchain as evidence can also be used as the credit assessment data in the credit assessment of the user, a process of performing credit assessment on the user and a process of creating the real rental transaction online for the user based on the credit assessment result can form a completely closed service loop, and the electronic rental contract that is created online for the user can be reversely used in the credit assessment of the user to form a personal credit record of the user.

The following describes the present specification by using specific implementations in combination with specific application scenarios.

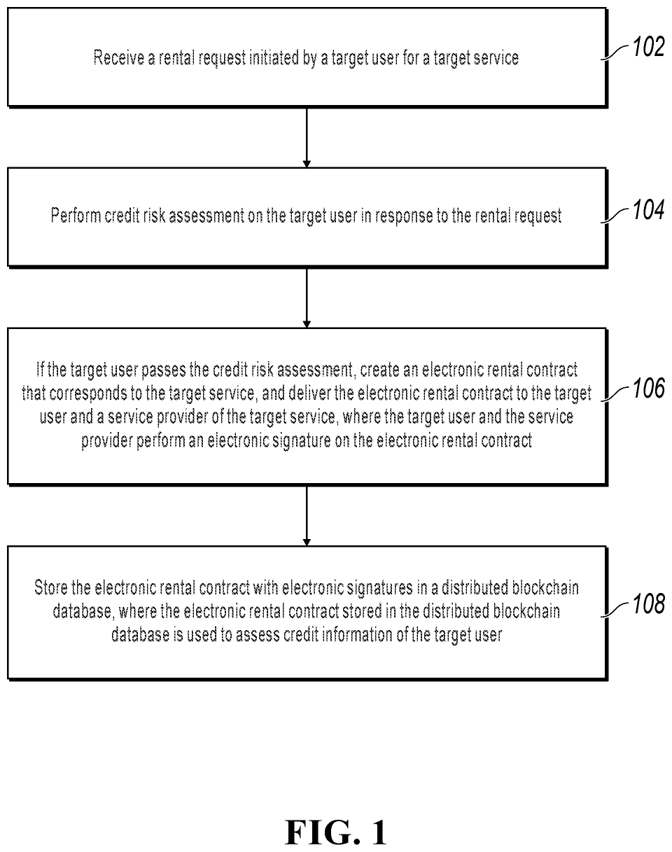

FIG. 1 shows a blockchain-based service rental method, according to an implementation of the present specification. The method is applied to a rental service system and includes the following steps:

Step 102: Receive a rental request initiated by a target user for a target service.

Step 104: Perform credit risk assessment on the target user in response to the rental request.

Step 106: If the target user passes the credit risk assessment, create an electronic rental contract that corresponds to the target service.

Step 108: Perform an electronic signature on the electronic rental contract based on a credit private key, and store the electronic rental contract with electronic signatures in a distributed blockchain database, where the electronic rental contract stored in the distributed blockchain database is used to assess credit information of the target user.

The blockchain described in the present specification may include any type of blockchain network. In actual applications, any one of a public chain, a private chain, or a consortium chain may be used.

The electronic rental contract may include an electronic document that is signed by the user and a rental service provider when the user requests a rental service provided by the rental service provider and that stipulates rights and obligations of both parties. For example, if the target service is a house rental service, the electronic rental contract may be a house electronic rental contract signed by a lessee and a lessor.

With reference to an application scenario where the user rents a house online, the following describes the technical solution in the present specification in detail by using an example where the target service is the house rental service and the electronic rental contract is an electronic rental contract.

It is worthwhile to note that the house rental service is merely used as an example of the target service. Apparently, the technical solution described in the present specification may also be used in another similar rental service scenario.

For example, the technical solution described in the present specification may also be equivalently applied to a shared product (for example, a shared bicycle or a shared vehicle) rental service or another similar rental service scenario. Details are omitted in the present specification for simplicity.

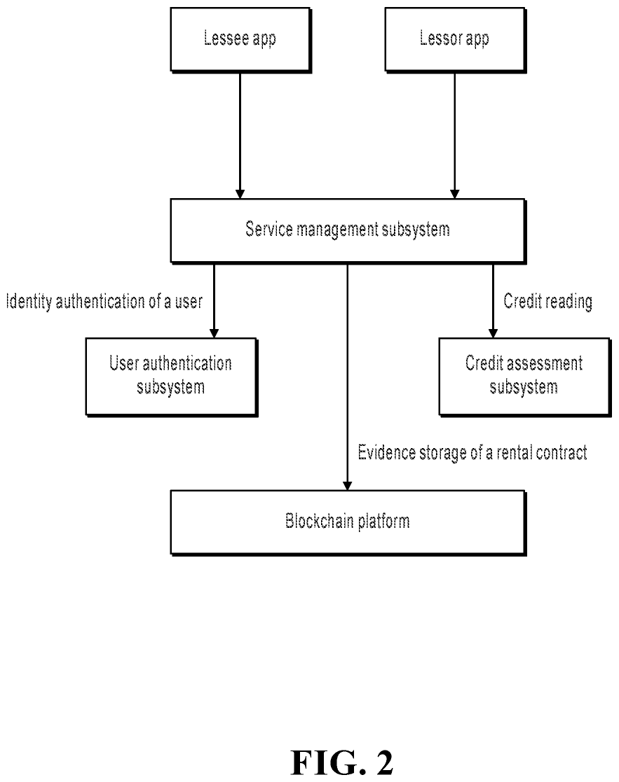

FIG. 2 is a system architectural diagram illustrating a house rental system, according to the present specification.

As shown in FIG. 2, in the present specification, the house rental system may include house rental client software, a service management subsystem, a credit assessment subsystem, a user authentication subsystem, and a blockchain platform.

The house rental client software (for example, an application (app)) may be further divided into lessee client software and lessor client software.

The lessee client software can provide, for the lessee, access to services such as account management, house retrieval, and house electronic rental contract management. The lessee can perform house retrieval online and initiate a house rental request online by using the function access shown above. The lessee house rental system creates a real house electronic rental contract online, completes an online rental transaction with the lessor, and performs online management on the signed house electronic rental contract.

The lessor client software can provide, for the lessor, access to services such as account management, house management, and house electronic rental contract management. The lessor can submit real house information to the house rental system by using the function access shown above. When the lessee initiates a house rental request online, the house rental system creates a real house electronic rental contract online, completes an online rental transaction with the lessee, and performs online management on the signed house electronic rental contract.

The service management subsystem may be separately interconnected with the credit assessment subsystem, the user authentication subsystem, and the blockchain platform.

The service management subsystem can complete identity authentication of the lessee by interacting with the user authentication subsystem.

In addition, the service management subsystem can interact with the credit assessment subsystem, to complete credit risk assessment of the lessee. After the lessee passes the credit risk assessment, the service management subsystem can create a corresponding house electronic rental contract online for the lessee, and perform an electronic signature on the house electronic rental contract by using a credit private key.

Further, the service management subsystem can interact with the blockchain platform, to store the house electronic rental contract with electronic signatures in a distributed blockchain database platform as evidence.

During implementation, the house rental management platform can be divided into two parts: a service module and a back end management module.

The service module can separately provide corresponding service interfaces (API) for the lessee client software and the lessor client software. For example, both the lessee client software and the lessor client software are web client software. The service management subsystem can use a Representational State Transfer (REST) architecture that provides a service for the web client software, and the service module of the service management subsystem can provide RESTful service interfaces for the lessee client software and the lessor client software.

The back end management module can provide, for a related house rental manager (for example, an urban government staff), a back end operation interface for managing house rental, and provide, in the back end operation interface for the house rental manager, access to functions such as account management, house retrieval, house management, and house electronic rental contract management.

By using function entries shown above, the house rental manager can implement management of basic house rental accounts of three types of users, such as the lessor, the lessee, and the house rental manager, implement a management function for extended attributes such as credit information (such as credit scores) and house rental credit records of the lessor and the lessee, implement a conditional search function based on a house database, implement management functions such as recording, review, modification, deletion, house ownership change, and list query of the house, and implement maintenance and management of the electronic rental contract template, and management functions such as creation, signature, evidence storage, inspection, and retrieval of the electronic rental contract.

It is worthwhile to note that the previously described function access is merely an example. In actual applications, corresponding function access can be flexibly configured in the back end operation interface based on an actual house rental management need. For example, in addition to the previously described function access, function access of house information monitoring and permission management may be further configured, so that the house rental manager can monitor each entry of house and perform permission management on the three types of users such as the lessor, the lessee, and the house rental manager by using the function access. Details are omitted in the present specification for simplicity.

The blockchain platform is configured to provide an evidence storage service for trusted data generated by an individual in a rental procedure. For example, the electronic rental contract signed by the lessee and the lessor, and a performance record of the lessee and a performance record of the lessor that correspond to the electronic rental contract can be stored in the distributed blockchain database platform as evidence.

The credit assessment subsystem may interact with the blockchain platform, read, from the blockchain platform, the trusted data generated by the individual in the rental procedure, create a credit assessment model based on the read trusted data, and perform credit assessment on the lessee and the lessor, to obtain credit information of the lessee and credit information of the lessor.

For example, the credit assessment model may be a credit score model, and the credit information may be a credit score obtained after credit assessment is performed on the lessee and the lessor by using the credit score model.

It is worthwhile to note that, in actual applications, the credit assessment subsystem and the identity authentication subsystem may be not only subsystems integrated into a system architecture of the house rental system but also third-party subsystems interconnected with the service management subsystem. In other words, in actual applications, the house rental system may be interconnected with third-party systems to complete an identity authentication service and a credit risk assessment service for the lessee. Implementations are not limited in the present specification.

The following further describes the technical solution in the present specification with reference to the system architecture of the rental management system shown in FIG. 2.

In the present specification, the lessor may access, by using the lessor client software, a service interface provided by the service management subsystem, and upload, onto the service management subsystem, related rent information (for example, basic information of a house, a rent, and a rent payment method) of a house to be rented. In addition, the house rental manager can review, by using the back end operation interface of the service management subsystem, the rent information uploaded by the lessor, and then record, in a standardized data format, the real house information in the service management subsystem after the rent information passes the review.

The service management subsystem can locally maintain, in a list form, the real house information that passes the review of the house rental manager and that is recorded in the standardized data format. In addition, the lessee may access, by using the lessee client software, a service interface provided by the service management subsystem, synchronize, for local display, information in the lessee client software with a real house list (namely, a trusted service list) maintained by the service management subsystem, and perform house retrieval on the real house list by using the lessee client software.

After identifying an appropriate house, the lessee can initiate and submit a house rental request to the service management subsystem by using the lessee client software. The rental request may include related information of the house to be rented, such as account information of the lessee.

In a shown implementation, after receiving the rental request, the service management subsystem may first perform identity authentication on the lessee.

It is worthwhile to note that, in the present specification, performing identity authentication on the lessee means verifying a real identity of the lessee in a real-name system, for example, determining whether a user of a lessee account is the lessee.

A specific method of performing identity authentication on the lessee is not particularly limited in the present specification.

For example, in an implementation, identity authentication of the lessee may be completed in a facial authentication method. In this case, after receiving the rental request, the service management subsystem may send, to the lessor client software, a prompt message for collecting a facial image. In addition, after receiving the prompt message, the lessor client software may immediately invoke a camera component mounted on a terminal device where the lessor client software is located, to collect a facial image of the lessee, and then upload the collected facial image onto the service management subsystem. After receiving the facial image, the service management subsystem may further upload the facial image onto the identity authentication subsystem, and the identity authentication subsystem compares the facial image with a facial image sample that is reserved in the system and that is bound to account information of the lessee. If the facial image matches the facial image sample, it indicates that the rental request is a rental request initiated by the lessee, and in this case, the identity authentication of the lessee succeeds.

In the present specification, after the identity authentication of the lessee succeeds, the service management subsystem may further interact with the credit assessment subsystem to perform credit risk assessment on the lessee.

In a shown implementation, after the identity authentication of the lessee succeeds, the service management subsystem may interact with the credit assessment subsystem, read a credit score of the lessee from the credit assessment subsystem, and then compare the read credit score with a preconfigured risk threshold to determine whether there is a credit risk of the lessee.

For example, a higher credit score indicates better credit of the user. The read credit score may be compared with the preconfigured risk threshold, to determine whether the credit score is less than the risk threshold. If the credit score is less than the risk threshold, it may be determined that the lessee fails to pass the credit risk assessment, and in this case, the lessee is a risky user. Otherwise, if the credit score is greater than or equal to the risk threshold, it may be determined that the lessee passes the credit risk assessment.

Certainly, in actual applications, the previously described process of comparing the credit score with the risk threshold may also be performed by the credit assessment subsystem. Implementations are not particularly limited in the present specification.

If the lessee fails to pass the credit risk assessment, the rental request initiated by the lessee may be directly terminated. Otherwise, if the lessee passes the credit risk assessment, the service management subsystem may automatically create an electronic rental contract for the user based on a house electronic rental contract template maintained in the system and the house information requested by the lessee.

Certainly, in actual applications, the electronic rental contract may also be manually created by the house rental manager by using the back end operation interface provided by the service management subsystem. Implementations are not particularly limited in the present specification.

In addition, after creating the electronic rental contract for the lessee, the service management subsystem may synchronize information in the lessee client software and information in the lessor client software with the created electronic rental contract, and separately display the created electronic rental contract for the lessee and the lessor. The lessee and the lessor confirm content of the electronic rental contract, and after confirming the content, the lessee and the lessor perform an electronic signature on the electronic rental contract.

A specific operation method for the lessee and the lessor to perform an electronic signature on the electronic rental contract is not particularly limited in the present specification.

In a shown implementation, after checking and confirming the content of the electronic rental contract, the lessee and the lessor may submit personal signatures on the electronic rental contract by using touchscreen terminal devices where client software is located, to form electronic signatures, and then upload the electronic rental contract with the electronic signatures onto the service management subsystem.

In another shown implementation, if the lessee and the lessor have valid private keys allocated by a Certified Authority (CA) institution, the lessee and the lessor may also perform an electronic signature on the electronic rental contract based on the private keys, and then upload the electronic rental contract with the electronic signatures onto the service management subsystem. Subsequently, after receiving the electronic rental contract with the electronic signatures, the service management subsystem may verify the electronic signatures of the electronic rental contract by using a public key that corresponds to the private keys of the lessee and the lessor. If the verification succeeds, it indicates that the electronic rental contract is a valid contract document.

In the present specification, after the service management subsystem receives the electronic rental contract with the electronic signatures of the lessee and the lessor, both the lessee and the lessor have successfully signed the electronic rental contract.

The service management subsystem may generate signature records indicating that the lessee and the lessor have confirmed and signed the electronic rental contract, and then release the signature records in the blockchain platform. After node devices in the blockchain platform perform consensus processing on the signature records, the signature records are stored in the distributed blockchain database as evidence, so that a retrospective query can be performed on signature actions of the lessee and the lessor in the blockchain in the future.

In addition, the service management subsystem may release, in the blockchain platform, the electronic rental contract with the electronic signatures of the lessee and the lessor, and after the node devices in the blockchain platform perform consensus processing on the electronic rental contract, the electronic rental contract is stored in the distributed blockchain database as evidence, so that a retrospective query can be performed on the electronic rental contract in the blockchain in the future.

It is worthwhile to note that, the consensus algorithm that is used and the specific consensus process that is performed when consensus processing is performed on released data in the blockchain platform are omitted in the present specification for simplicity. When implementing the technical solution in the present specification, a person skilled in the art may refer to records in related technologies.

In the present specification, after the electronic rental contract is successfully recorded and stored in the distributed blockchain database, a rental transaction between the lessee and the lessor has been concluded, and the lessee can perform the electronic rental contract based on a contract in the electronic rental contract.

In a shown implementation, the lessor may further generate a performance record of the lessee by using the lessor client software based on the actual performance of the lessee for the electronic rental contract and upload the generated performance record onto the service management subsystem.

For example, the service management subsystem may send a standardized template of the performance record to the lessor client software, and the lessor may fill related performance information in the standardized template based on the actual performance of the lessee, for example, performance information indicating whether the lessee pays a rent on schedule, performance information indicating whether the lessee maliciously sublets the house, and performance information indicating whether the lessee destroys hardware facilities in the house.

After receiving the performance record, the service management subsystem may release the performance record in the blockchain platform, and after the node devices in the blockchain platform perform consensus processing on the performance record, the performance record is stored in the distributed blockchain database as evidence, so that evidence storage of the performance record of the lessee can be implemented in the blockchain in the future.

In addition, the credit assessment subsystem may interact with the blockchain platform, read the electronic rental contract and the performance record of the lessee that are stored in the blockchain platform, perform modeling by using the read electronic rental contract and the read performance record of the lessee as credit assessment data to construct a credit assessment model, and perform credit assessment on the lessee again to obtain a credit score of the lessee.

As such, if the lessee does not perform the contract after concluding the rental transaction with the lessor, a negative performance record is generated, and after the credit assessment subsystem performs credit assessment on the lessee again based on updated data in the blockchain platform, a next credit assessment result of the lessee may be affected. Therefore, once the lessee does not perform the contract, a next rental request of the lessee is directly affected. For example, after the lessee initiates a house rental request next time, the rental request may be directly rejected by the system because of a low credit score of the lessee.

It can be seen that, in the method, the lessee may be positively encouraged to perform each rental transaction. In addition, a process of performing credit assessment on the user and a process of creating the real rental transaction online for the user based on the credit assessment result can form a completely closed service loop.

Correspondingly, in actual applications, the lessee may further generate a performance record of the lessor by using the lessee client software based on actual performance of the lessor for the electronic rental contract, and upload the generated performance record onto the service management subsystem.

For example, the service management subsystem may still send the standardized template of the performance record to the lessee client software, and the lessee may fill related performance information in the standardized template based on the actual performance of the lessor, for example, performance information indicating whether the lessor maliciously sublets the house, performance information indicating whether the house is inconsistent with description, performance information indicating whether hardware devices in the house are insufficient, and performance information indicating whether the lessor maliciously retains a deposit.

In addition, after receiving the performance record, the service management subsystem may also store the performance record in the blockchain platform as evidence. The credit assessment subsystem may perform credit assessment on the lessor again based on the electronic rental contract and the performance record of the lessor that are stored in the blockchain platform, to obtain a credit score of the lessor.

Subsequently, the service management subsystem may also perform credit risk assessment on the lessor based on the credit score of the lessor. For a specific credit risk assessment method, references can be made to descriptions in the previously described implementations. Details are omitted for simplicity. If the lessor fails to pass the credit risk assessment (for example, the credit score is very low), the house provided by the lessor may be directly marked as an untrusted house in the real house list, or the house provided by the lessor may be directly deleted from the real house list, or in other words, the house provided by the lessor is “withdrawn”.

In the previously described technical solution, based on the credit risk assessment result of the user who requests the rental service, the electronic rental contract may be automatically created for the user by combining the credit risk assessment mechanism with the evidence storage mechanism of the blockchain, and the electronic rental contract with the electronic signatures can be stored in the blockchain as evidence, so that the real rental transaction can be generated online, in the rental service system by using a feature that stored evidence data in the blockchain is unchangeable, for the user who requests the rental service.

In addition, because the electronic rental contract stored in the blockchain as evidence can also be used as the credit assessment data in the credit assessment of the user, a process of performing credit assessment on the user and a process of creating the real rental transaction online for the user based on the credit assessment result can form a completely closed service loop, and the electronic rental contract that is created online for the user can be reversely used in the credit assessment of the user, to form a personal credit record of the user.

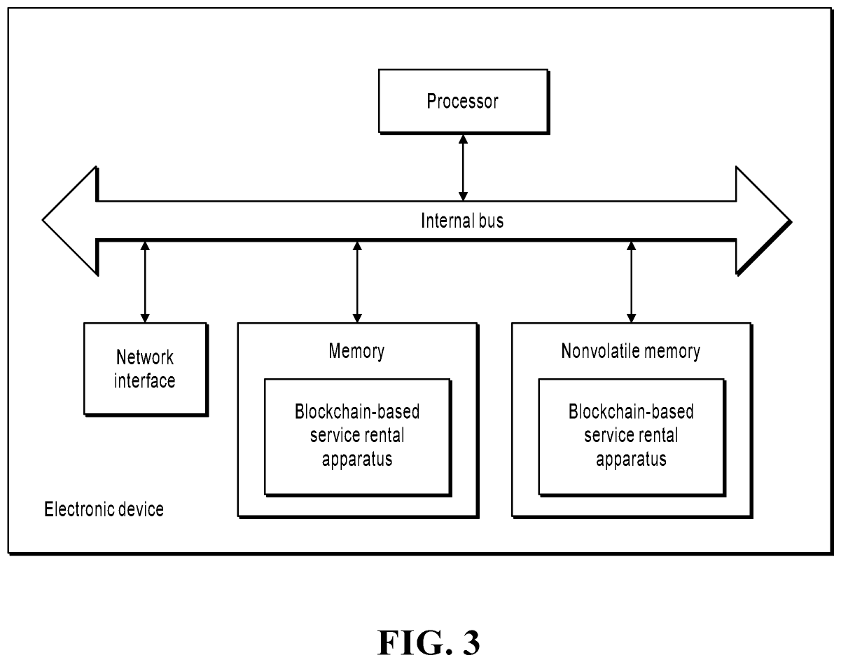

Corresponding to the previously described method implementations, the present specification further provides an implementation of a blockchain-based service rental apparatus. The present implementation of the blockchain-based service rental apparatus in the present specification may be applied to an electronic device. The apparatus implementation can be implemented by software, hardware, or a combination of hardware and software. The software implementation is used as an example. As a logical apparatus, the apparatus is formed by reading a corresponding computer program instruction in a non-volatile memory to a memory by a processor of an electronic device where the apparatus is located. In terms of hardware, FIG. 3 is a hardware structural diagram illustrating an electronic device where a blockchain-based service rental apparatus is located, according to the present specification. In addition to a processor, a memory, a network interface, and a non-volatile memory shown in FIG. 3, the electronic device where the apparatus in the present implementation is located can usually include other hardware based on an actual function of the electronic device. Details are omitted for simplicity.

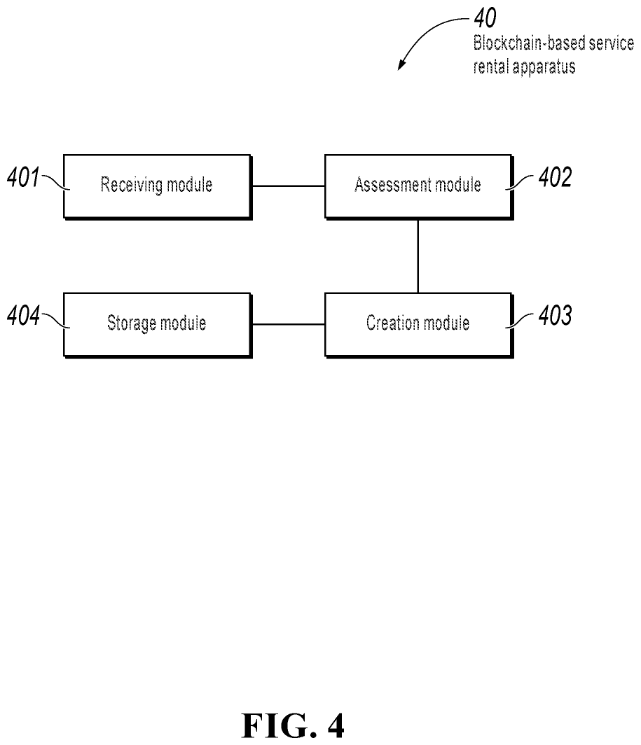

FIG. 4 is a block diagram illustrating a blockchain-based service rental apparatus, according to an example implementation of the present specification.

Referring to FIG. 4, the blockchain-based service rental apparatus 40 may be applied to the electronic device shown in FIG. 3, and includes a receiving module 401, an assessment module 402, a creation module 403, and a storage module 404.

The receiving module 401 is configured to receive a rental request initiated by a target user for a target service.

The assessment module 402 is configured to perform credit risk assessment on the target user in response to the rental request.

The creation module 403 is configured to: if the target user passes the credit risk assessment, create an electronic rental contract that corresponds to the target service, and deliver the electronic rental contract to the target user and a service provider of the target service, where the target user and the service provider perform an electronic signature on the electronic rental contract.

The storage module 404 is configured to store the electronic rental contract with electronic signatures in a distributed blockchain database, where the electronic rental contract stored in the distributed blockchain database is used to assess credit information of the target user.

In the present implementation, the receiving module 401 is further configured to: receive a performance record of the target user and a performance record of the service provider that correspond to the electronic rental contract; and the storage module 404 is further configured to store the performance records in the distributed blockchain database.

In the present implementation, the assessment module 402 is further configured to: read the electronic rental contract stored in the distributed blockchain database, and the performance record of the target user and the performance record of the service provider that correspond to the electronic rental contract; and perform credit assessment on the target user and the service provider based on the read electronic rental contract and the read performance records, to obtain the credit information of the target user and credit information of the service provider.

In the present implementation, the apparatus 40 further includes: an authentication module 405 (not shown in FIG. 4), configured to perform identity authentication on the target user in response to the rental request, where if the identity authentication of the target user succeeds, the assessment module 403 further performs credit risk assessment on the target user.

In the present implementation, the credit information includes a credit score.

The assessment module 402 is further configured to: read a credit score of the target user; determine whether the credit score of the target user is less than a predetermined threshold; and if the credit score of the target user is less than the predetermined threshold, determine that the target user fails to pass the credit risk assessment; or if the credit score of the target user is not less than the predetermined threshold, determine that the target user passes the credit risk assessment.

In the present implementation, the assessment module 402 is further configured to: perform credit risk assessment on the service provider; and if the service provider fails to pass the credit risk assessment, mark the service provided by the service provider as an untrusted service; or delete the service from a trusted service list.

In the present implementation, the target service is a house rental service.

For an implementation process of functions and roles of each module in the apparatus, references can be made to an implementation process of a corresponding step in the previously described method. Details are omitted here for simplicity.

Because an apparatus implementation basically corresponds to a method implementation, for related parts, references can be made to related descriptions in the method implementation. The previously described apparatus implementation is merely an example. The modules described as separate parts may or may not be physically separate, and parts displayed as modules may or may not be physical modules, may be located in one position, or may be distributed on a plurality of network modules. Some or all of the modules can be selected based on actual needs to achieve the objectives of the solutions in the present specification. A person of ordinary skill in the art can understand and implement the implementations of the present specification without creative efforts.

The system, apparatus, or module described in the previously described implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

The present specification further provides an implementation of an electronic device that corresponds to the previously described method implementations. The electronic device includes a processor, and a memory configured to store a machine-executable instruction, where the processor and the memory are generally connected to each other by using an internal bus. In another possible implementation, the device may further include an external interface, to communicate with another device or component.

In the present implementation, by reading and executing a machine-executable instruction that is stored in the memory and that corresponds to blockchain-based service rental control logic, the processor is enabled to: receive a rental request initiated by a target user for a target service; perform credit risk assessment on the target user in response to the rental request; if the target user passes the credit risk assessment, create an electronic rental contract that corresponds to the target service, and deliver the electronic rental contract to the target user and a service provider of the target service, where the target user and the service provider perform an electronic signature on the electronic rental contract; and store the electronic rental contract with electronic signatures in a distributed blockchain database, where the electronic rental contract stored in the distributed blockchain database is used to assess credit information of the target user.

In the present implementation, by reading and executing a machine-executable instruction that is stored in the memory and that corresponds to blockchain-based service rental control logic, the processor is enabled to: receive a performance record of the target user and a performance record of the service provider that correspond to the electronic rental contract; and store the performance records in the distributed blockchain database.

In the present implementation, the credit information includes a credit score; and by reading and executing a machine-executable instruction that is stored in the memory and that corresponds to blockchain-based service rental control logic, the processor is enabled to: read the electronic rental contract stored in the distributed blockchain database, and the performance record of the target user and the performance record of the service provider that correspond to the electronic rental contract; and perform credit assessment on the target user and the service provider based on the read electronic rental contract and the read performance records, to obtain the credit information of the target user and credit information of the service provider.

In the present implementation, by reading and executing a machine-executable instruction that is stored in the memory and that corresponds to blockchain-based service rental control logic, the processor is enabled to: perform identity authentication on the target user in response to the rental request; and if the identity authentication of the target user succeeds, further perform credit risk assessment on the target user.

In the present implementation, the credit information includes a credit score; and by reading and executing a machine-executable instruction that is stored in the memory and that corresponds to blockchain-based service rental control logic, the processor is enabled to: read a credit score of the target user; determine whether the credit score of the target user is less than a predetermined threshold; and if the credit score of the target user is less than the predetermined threshold, determine that the target user fails to pass the credit risk assessment; or if the credit score of the target user is not less than the predetermined threshold, determine that the target user passes the credit risk assessment.

In the present implementation, by reading and executing a machine-executable instruction that is stored in the memory and that corresponds to blockchain-based service rental control logic, the processor is enabled to: perform credit risk assessment on the service provider; and if the service provider fails to pass the credit risk assessment, mark the service provided by the service provider as an untrusted service; or delete the service from a trusted service list.

A person skilled in the art can easily figure out another implementation of the present specification after thinking over the specification and practicing the present disclosure here. The present specification is intended to cover any variations, uses, or adaptations of the present specification, and these variations, uses, or adaptations follow the general principles of the present specification and include common knowledge or conventional techniques that are not disclosed in the existing technology of the present specification. The specification and the implementations are merely considered as examples, and the actual scope and the spirit of the present specification are pointed out by the following claims.

It should be understood that the present specification is not limited to the precise structures that have been described above and shown in the drawings, and various modifications and changes can be made without departing from the scope of the present disclosure. The scope of the present specification is limited by the appended claims only.

The previous descriptions are merely example implementations of the present specification, but are not intended to limit the present specification. Any modification, equivalent replacement, or improvement made without departing from the spirit and principle of the present specification shall fall within the protection scope of the present specification.

The subject matter disclosed herein may provide, in some implementations, various technical advantages and effects. The electronic rental contract with the electronic signature generated using the blockchain can be stored as evidence data in the blockchain. This evidence data stored in the blockchain can be used for future credit assessments and generation of later contracts. Thus, a single blockchain can be used to perform credit risk assessments, and to store evidence generated from the credit risk assessments (e.g., an electronic rental contract), where the evidence can be relied on for future credit risk assessments, thus providing a closed blockchain-based service loop. Because of the distributed nature of the stored data in the blockchain, the blockchain-based closed service loop provides a transparent credit record that is secured against fraudulent modifications of a user's credit.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving a rental request initiated by a target user for a target service in a blockchain network;
performing a credit risk assessment on the target user in response to the rental request;
determining that the target user passes the credit risk assessment;
in response to determining that the target user passes the credit risk assessment, generating an electronic rental contract that corresponds to the target service;
delivering the electronic rental contract to the target user and a service provider of the target service, wherein the target user and the service provider perform an electronic signature on the electronic rental contract; and
storing the electronic rental contract with electronic signatures in a distributed blockchain database of the blockchain network, wherein the electronic rental contract stored in the distributed blockchain database is used to assess credit information of the target user.

2. The computer-implemented method of claim 1, comprising:
receiving a performance record of the target user and a performance record of the service provider that correspond to the electronic rental contract; and
storing the performance records in the distributed blockchain database.

3. The computer-implemented method according to claim 2, further comprising:
reading the electronic rental contract stored in the distributed blockchain database, the performance record of the target user and the performance record of the service provider that correspond to the electronic rental contract; and
performing credit assessment on the target user and the service provider based on the electronic rental contract, the performance record of the target user and the performance record of the service provider, to obtain the credit information of the target user and credit information of the service provider.

4. The computer-implemented method according to claim 2, wherein the credit information comprises a credit score, and wherein performing credit risk assessment on the target user comprises:
reading a credit score of the target user;
determining whether the credit score of the target user is less than a predetermined threshold; and
in response to determining that the credit score of the target user is less than the predetermined threshold, determining that the target user fails to pass the credit risk assessment;
or in response to determining that the credit score of the target user is not less than the predetermined threshold, determining that the target user passes the credit risk assessment.

5. The computer-implemented method according to claim 1, wherein performing the credit risk assessment on the target user in response to the rental request comprises:
performing identity authentication on the target user in response to the rental request;
determining that the identity authentication of the target user succeeds; and
in response to determining that the identity authentication of the target user succeeds, further performing credit risk assessment on the target user.

6. The computer-implemented method according to claim 1, further comprising:
performing credit risk assessment on the service provider;
determining that the service provider fails to pass the credit risk assessment; and
in response to determining that the service provider fails to pass the credit risk assessment, marking a service provided by the service provider as an untrusted service or deleting the service from a trusted service list.

7. The computer-implemented method according to claim 1, wherein the target service is a house rental service.

8. A non-transitory, computer-readable medium storing one or more instructions executable by a computer system to perform operations comprising:
receiving a rental request initiated by a target user for a target service in a blockchain network;
performing a credit risk assessment on the target user in response to the rental request;
determining that the target user passes the credit risk assessment;
in response to determining that the target user passes the credit risk assessment, generating an electronic rental contract that corresponds to the target service;
delivering the electronic rental contract to the target user and a service provider of the target service, wherein the target user and the service provider perform an electronic signature on the electronic rental contract; and
storing the electronic rental contract with electronic signatures in a distributed blockchain database of the blockchain network, wherein the electronic rental contract stored in the distributed blockchain database is used to assess credit information of the target user.

9. The non-transitory, computer-readable medium of claim 8, wherein the operations further comprise:
receiving a performance record of the target user and a performance record of the service provider that correspond to the electronic rental contract; and
storing the performance records in the distributed blockchain database.

10. The non-transitory, computer-readable medium of claim 9, wherein the operations further comprise:
reading the electronic rental contract stored in the distributed blockchain database, the performance record of the target user and the performance record of the service provider that correspond to the electronic rental contract; and
performing credit assessment on the target user and the service provider based on the electronic rental contract, the performance record of the target user and the performance record of the service provider, to obtain the credit information of the target user and credit information of the service provider.

11. The non-transitory, computer-readable medium of claim 9, wherein the credit information comprises a credit score, and wherein performing credit risk assessment on the target user comprises:
reading a credit score of the target user;
determining whether the credit score of the target user is less than a predetermined threshold; and
in response to determining that the credit score of the target user is less than the predetermined threshold, determining that the target user fails to pass the credit risk assessment;
or in response to determining that the credit score of the target user is not less than the predetermined threshold, determining that the target user passes the credit risk assessment.

12. The non-transitory, computer-readable medium of claim 8, wherein performing the credit risk assessment on the target user in response to the rental request comprises:
performing identity authentication on the target user in response to the rental request;
determining that the identity authentication of the target user succeeds; and
in response to determining that the identity authentication of the target user succeeds, further performing credit risk assessment on the target user.

13. The non-transitory, computer-readable medium of claim 8, wherein the operations further comprise:
performing credit risk assessment on the service provider;
determining that the service provider fails to pass the credit risk assessment; and
in response to determining that the service provider fails to pass the credit risk assessment, marking a service provided by the service provider as an untrusted service or deleting the service from a trusted service list.

14. The non-transitory, computer-readable medium of claim 8, wherein the target service is a house rental service.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a rental request initiated by a target user for a target service in a blockchain network;
performing a credit risk assessment on the target user in response to the rental request;
determining that the target user passes the credit risk assessment;
in response to determining that the target user passes the credit risk assessment, generating an electronic rental contract that corresponds to the target service;
delivering the electronic rental contract to the target user and a service provider of the target service, wherein the target user and the service provider perform an electronic signature on the electronic rental contract; and
storing the electronic rental contract with electronic signatures in a distributed blockchain database of the blockchain network, wherein the electronic rental contract stored in the distributed blockchain database is used to assess credit information of the target user.

16. The computer-implemented system of claim 15, wherein the operations further comprise:
receiving a performance record of the target user and a performance record of the service provider that correspond to the electronic rental contract; and
storing the performance records in the distributed blockchain database.

17. The computer-implemented system of claim 16, further comprising:
reading the electronic rental contract stored in the distributed blockchain database, the performance record of the target user and the performance record of the service provider that correspond to the electronic rental contract; and
performing credit assessment on the target user and the service provider based on the electronic rental contract, the performance record of the target user and the performance record of the service provider, to obtain the credit information of the target user and credit information of the service provider.

18. The computer-implemented system of claim 16, wherein the credit information comprises a credit score, and wherein performing credit risk assessment on the target user comprises:
reading a credit score of the target user;
determining whether the credit score of the target user is less than a predetermined threshold; and
in response to determining that the credit score of the target user is less than the predetermined threshold, determining that the target user fails to pass the credit risk assessment;
or in response to determining that the credit score of the target user is not less than the predetermined threshold, determining that the target user passes the credit risk assessment.

19. The computer-implemented system of claim 15, wherein performing the credit risk assessment on the target user in response to the rental request comprises:
performing identity authentication on the target user in response to the rental request;
determining that the identity authentication of the target user succeeds; and
in response to determining that the identity authentication of the target user succeeds, further performing credit risk assessment on the target user.

20. The computer-implemented system of claim 15, wherein the operations further comprise:
performing credit risk assessment on the service provider;
determining that the service provider fails to pass the credit risk assessment; and
in response to determining that the service provider fails to pass the credit risk assessment, marking a service provided by the service provider as an untrusted service or deleting the service from a trusted service list.
